(19) United States
(12) Patent Application Publication
(10) Pub. No.: US 2004/0155086 A1
(43) Pub. Date: Aug. 12, 2004

(54) Contacting of continuous products

(76) Inventor: Nikola Dragov, Maria Enzersdorf (AT)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/727,030

(22) Filed: Dec. 2, 2003

(30) Foreign Application Priority Data
Dec. 4, 2002 (AT) A 1812/2002

(51) Int. Cl. B23Q 15/00

(52) U.S. Cl. 226/15; 226/21

(57) ABSTRACT

The invention pertains to the electrical contacting of a continuously moving metered material web (7), in particular a flexible flat cable, a so-called FFC, during its processing or manufacture.

The invention is characterized in that at least two contacting stations (5, 11; 5′, 11′) are provided that perform the contacting alternately.

In a first variant there are two, preferably three buffers for the metered material web, and the contacting stations are fixed in place; in a second variant, the contacting stations move during the contacting with the metered material web and then move back without making contact.

The invention pertains to the automated electrical contacting of at least partly electrically conducting continuous products, so-called metered material webs, in particular of flexible flat cables (FFC), for processing.

One problem that is more or less opposed to this contacting is described together with its solution in JP 2000-79913 A: In this regard, it is a matter of removing foreign matter from movie film before the film is sent to a projector. Since the foreign matter adheres to the polyvinyl film primarily due to static electricity, first the electrostatic charge is neutralized by means of devices not described therein, but that are not in mechanical contact with the film according to the drawing, so that any existing foreign matter is removed by means of rollers.

From DE 40 11 004A a device is known with which a continuous product can be subjected to a corona treatment with an electrode. To do this, it is passed under the electrode and treated by using an electrically conductive roller that serves as the counter electrode. For what purpose this is done is not disclosed, nor is the nature of the continuous product. Also, no contact takes place, but rather only a corona treatment.

From U.S. Pat. No. 5,996,872A a device is known with which the position of the edge of a continuous product can be determined. In this case, two pairs of electrodes are provided, between which the edge region of the continuous product is pulled. One pair of electrodes is located entirely within the surface of the continuous product and is used as a reference for determining the capacitance and thickness of the continuous product; the pair of measuring electrodes is only partly covered, its capacitance depends on the degree of coverage and thus on the position of the edge of the continuous product, and after continuing calibration with the result of the pair of reference electrodes, it permits the determination of the edge position. With this device there is no electrical contact with the sheet in any way; the contact is only carried out between the pairs of electrodes.

In the conventional processing of continuous products or metered material webs (e.g., flat ribbon conductors, plates) it is necessary to generate an electrical voltage or current flow between the material to be treated and the tool (bath, etc.) for a particular processing step (e.g., galvanizing). Thus, the problem arises that for a stationary contacting site, the optimum continuous production sequence must be periodically interrupted for the processing of metered material webs, especially of electrically insulated metered material webs, in order to move the process material across the fixed-position contact point of the work station. Due to the absence of electrical supply at this time, the processing sequence must cease for this period of time.

For this reason, due to the forced periodic pauses during production, poor processing efficiency, and thus increased manufacturing costs, are incurred. In addition, there may occur undesirable formation of layers, for example, during electroplating, and it often happens that after the restart of the contacting, a certain amount of time will pass before the optimum processing parameters can be readjusted.

The purpose of the invention is to create a contacting that does not have there problems, and in particular one that will allow continuous processing wherein the process step assigned to and usually following the contacting, can occur without interruption of the contacting.

According to the invention, these objectives are realized in that at least two contacting stations are provided for the metered material web and they perform their contacting alternately.

A first variant is characterized in that at least one buffer is assigned to each contacting station for the metered material web.

A second variant is characterized in that the two contacting stations can move between two positions and they move with the metered material web making an electrical contact, from the first position to the second position, and then move from the second position back to the first position without making an electrical contact with the metered material web.

A third variant provides for a quasi-infinite number of contacting stations, preferably fixed in position with respect to the processing station, namely an electrically conducting web along which the metered material web is moved under electrical contact.

In all three ways a permanent, automated contacting of the material being processed is obtained, with simultaneous continuous transport, even through the section of electrical contacting, which makes possible uninterrupted continuous processing in the associated processing step.

On the side of the (insulated) metered material webs the contacting takes place either across already formed windows in the insulating material, where said windows are required in the finished product, or by means of mechanical perforation of the insulating material for purposes of contacting. In this case, it is consequently necessary to cut out a few millimeters of the length of the metered material webs in the perforation area. The third variant is preferred for use when the windows are already present, since they will have the necessary size for a slide contact.

Due to the invention an increase in quality of the finished products and an improvement in the efficiency of the production machinery can be obtained, which leads to reduced manufacturing costs.

The invention will be explained in greater detail below on the basis of the drawing. Shown are:

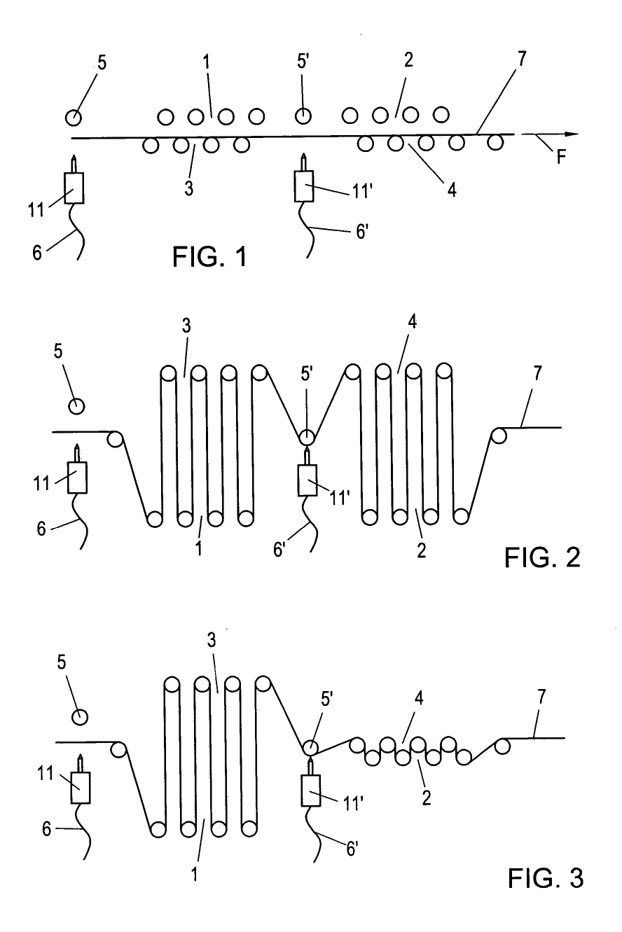

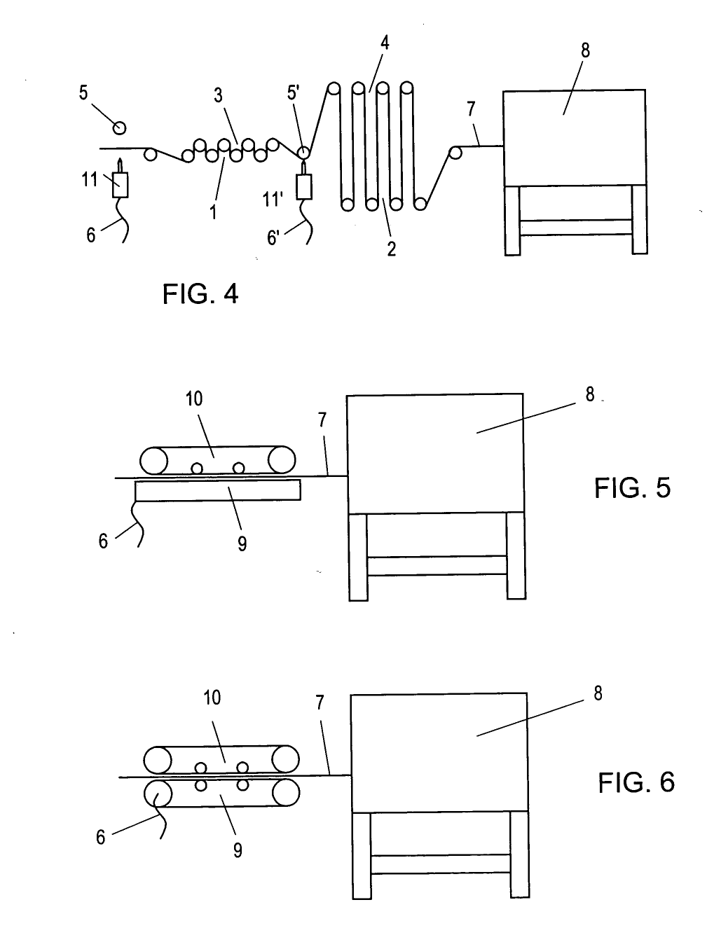

FIGS. 1 to 4, a first variant

FIGS. 5 and 6, a second variant in two embodiments, and

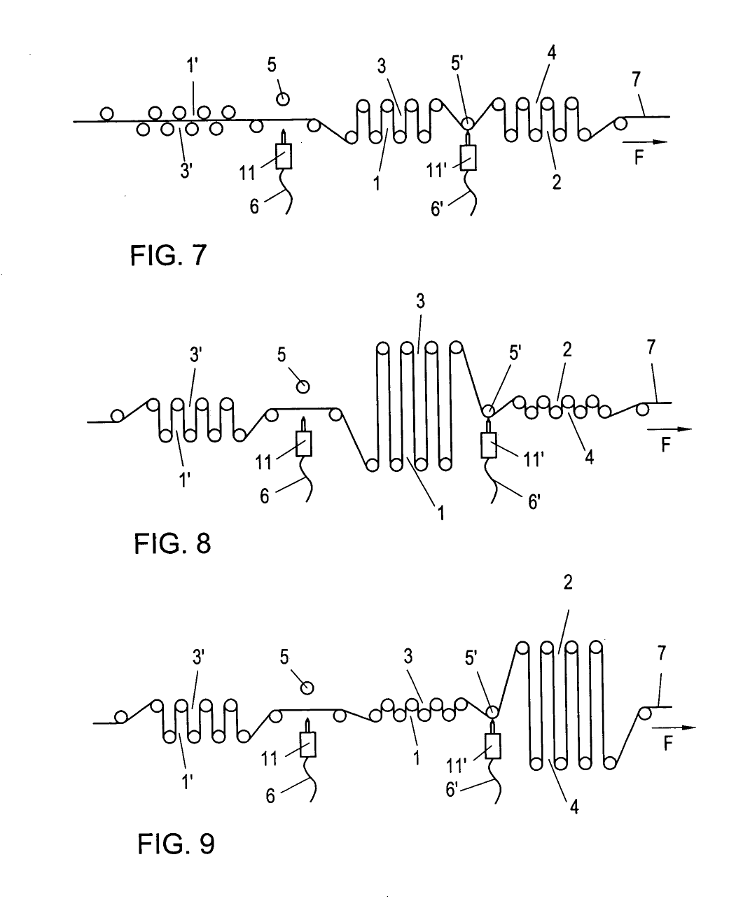

FIGS. 7 to 8, embodiments of the first variant of the invention.

First Variant: Stationary Power Supply Stations

FIGS. 1 to 4 show how the material to be processed—the metered material web 7—is moved past two stationary current or voltage sources 6, 6′ in the direction of the arrow F. The supply of power takes place by means of a contact element 11, 11′ that is pressed against the processed material 7 by means of an opposing form 5, 5′ (e.g., a roller). In the case of flat conductors, the contact takes place preferably at a region isolated during a previous manufacturing step, a so-called window. If no such window is available on the FFC, then the contact element 11, 11′ can be equipped with points of electrically conductive and mechanically solid material, preferably steel, and these points pass through the insulation of the FFC to form the contact. In this case, care must be taken that these sites (to be discarded later) are located at the end (and the start) of the end product so that no additional waste occurs.

In the illustrated embodiment, the contact element 11 and the opposing form 5 are designed to move with respect to each other; the contacting station as a whole is not movable, that is, it is fixed in position. At the end of the contacting, the material 7 to be processed is at rest with respect to the contact site 11, 5. The metered material web 7 is also moved past a contact station 5′, 11′ of the same design and at a distance from the contact station 5, 11, but if the former contacting site is closed, then the metered material web will be at rest with respect to this contacting site.

The continuous transport motion F necessary outside of the contacting system 5, 11; 5′, 11′ will be assured by a buffer system 1, 3, or 2, 4 for the metered material web, which is assigned to and extends in front of, for example, each contact station. This buffer system can be designed, for instance, by two known sets of rollers 1, 3 or 2, 4. These sets of rollers are designed to move opposite each other and guide the material being processed in a meandering form from the direction of travel of the material under process. By placing several rollers in series, a corresponding multiplication of the length of the possible relative motion of the sets of rollers 1, 3 or 2, 4 can be obtained as the length of the buffer. The buffers can be alternately filled with or emptied of the material 7 under process.

In the case of a closed contacting system 5′, 11′, at the beginning the buffer 2, 4 is filled and buffer 1, 3 is empty. The filling of the following (as indicated by the direction of arrow F) processing machine takes place on a continuous basis by emptying the buffer 2, 4. Buffer 1, 3 is filled at the same time. After emptying of the buffer 2, 4, the closing of the contacting 5, 11 will occur, and then the release of the electrical contacting 5′, 11′. The metered material web 7 will then be moved at a rate of advance V much greater in comparison to the processing speed F, from buffer 1, 3 to buffer 2, 4. To bridge the length of the additionally supplied metered material web an additional (illustrated in the variant shown in FIGS. 7 and 8), perhaps smaller buffer 1′, 3′ can be provided in front of the buffer 1, 3; otherwise a temporary loop will form in this region.

The requirement for an additional buffer is a function of the size of the buffers 1, 3 or 2, 4, and on the rate of advance V of the metered material web from one buffer to the other, in comparison to the “standard” operating speed F. After the buffer 2, 4 is entirely filled, the electrical contacting 5′, 11′ will be closed, the contacting system 5, 11 opened and the processing step will be continued.

FIGS. 7 and 8 describe the situation with three buffers 1, 3 or 2, 4 of essentially the same size, and the “prebuffer” 1′, 3′. In this embodiment the difference between the processing speed F and the rate of advance V is relatively low, i.e., V need only be a bit higher than 2F. Of course, the two speeds V1 for the processing station 5, 11 and V2 for the processing station 5′, 11′ need not be the same, however, this is an advantage for the layout and control, with regard to the possibility of using identical apparatus. If the available space is too constricted, then the choice of a greater V/F ratio is an advantage, since then the buffers can be kept small.

Thus, by placing at least two contacting units 5, 11;′ 5′, 11′ in series each with at least one associated intermediate buffer 1, 3 or 2, 4 with alternate closing of the electrical contacting, any interruption of the following processing step can be entirely avoided. Of course, the processing step could also be handled in front of the first buffer 1, 3, but in many cases the metered material web 7 will be separated at the end of the processing, so that a dependable contacting must occur before the processing station.

Second and Third Variant: Mobile Electrical Supply

In this variant, the contacting units execute their motion in one of two ways while they are in contact with the metered material web. The metered material web 7 being processed is moved past an appropriately designed surface that is running parallel to the direction of travel of the metered material web. The contacting is implemented, for example, by a flexible, electrically conducting material (e.g., steel wool web or soft metal brush). In the case of flat conductors, the contacting takes place preferably at a region insulated in a preceding manufacturing step.

The contacting unit itself is located either at rest and the window in the metered material web brushes against the contact surface featuring one large elongated form that forms the two contact sites, or the (small) contact surface is moved continuously at the speed of travel F of the metered material web 7 (or at a default relative speed). The contact between the contact window on the metered material web 7 and the contact unit 9 is handled by a suitable opposing form (e.g., an endless belt that is returned by use of rollers). With the contact unit stopped, the opposing form moves preferably at the speed of the metered material web, thus with zero relative speed.

In FIGS. 5 and 6 the path of the metered material web 7 is shown as a straight line, but it is also possible for it to have a meandering form, and also to design the contact surface of the contact unit the same, so that the frequency of the contact windows on the FFC is reduced, or the spacing between them can be increased. On both sides of the metered material web 7 there can be solid surfaces as contact surfaces (not shown), or on one side a surface 9 (FIG. 5) or on both sides, surfaces 9′ (FIG. 6) can be provided with moving, flexible elements, for example, belts 10. Whether the electrical contacting occurs on both sides or only on one side will depend on the particular application, particularly on the amount of current to be transmitted, and thus on the surface load occurring in the region of the current transfer.

1. Electrical contacting of a continuously moving metered material web (7), in particular a flexible flat cable, a so-called FFC, during its processing or manufacture, characterized in that at least two contacting stations (5, 11; 5′, 11′) are provided.

2. Contacting according to claim 1, characterized in that the two contacting stations perform the contacting alternately, that they are fixed in position and that at least one buffer (1, 3; 2, 4) is provided for each contacting station (5, 11; 5′, 11′) for the metered material web (7) to be contacted.

3. Contacting according to claim 2, characterized in that three buffers (1′, 3′; 1, 3; 2, 4) of essentially the same size are provided and that one contacting station (5, 11; 5′, 11′) is located between every two buffers.

4. Contacting according to claim 1, characterized in that the at least two contacting stations move together with the metered material web (7) while in contact with it, and then move back without contacting it.

5. Contacting according to one of claims 2 to 4 for electrically insulated conductor sheet(s) of metered material web (7), characterized in that each contacting station has electrical contact elements (11, 11′) with electrically conductive material points that penetrate the electrical insulation of the metered material web (7) down to its conductor path(s).

6. Contacting according to claim 1, characterized in that at least two contacting stations are designed as a cohesive, elongated contact region across which the metered material web (7) or its conductive webs move along in the region of contact windows.

7. Contacting according to one of claims 4 or 6, characterized in that a pressure piece that ensures the contact, preferably in the shape of an endless, revolving belt (10), is assigned to the electrical contact element (9) on the side of the metered material web facing away from the contact element.

8. Contacting according to claim 7, characterized in that the belt (10) revolves at the same speed as the metered material web (7).
